(19) United States
(12) Patent Application Publication
(10) Pub. No.: US 2004/0047159 A1
(43) Pub. Date: Mar. 11, 2004

(54) External accessory of car exhaust pipe

(76) Inventor: Pi-Fen Lee, Chia Yih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/237,962

(22) Filed: Sep. 10, 2002

(51) Int. Cl. B60Q 1/00

(52) U.S. Cl. 362/487

(57) ABSTRACT

An external accessory of a car exhaust pipe consists of a barrel fastening to the tail end of a car exhaust pipe, a coupler coupled with one end of the barrel having a housing compartment formed thereon and a front rim covered by a light radiation element, and a luminous element located in the housing compartment. The luminous element may emit alarming or decorative light which passes through the coupler to enable the tail end of the exhaust pipe to project alarming or decorative light to improve drive safety or achieve decorative effect.

### BACKGROUND OF THE INVENTION

1. Field of the Invention

The present invention relates to an external accessory of a car exhaust pipe and particularly an external accessory of a car exhaust pipe that has warning and decorative effects.

2. Description of the Prior Art

Nowadays many merchandises are designed and made with personalized flavor to appeal targeted customers. Event the common and standardized products may be coupled with various accessories to become unique with personalized appealing. For instance, many car lovers try to equip their cars with various personalized items and features to reflect their tastes and personality. To add accessories on the exhaust tail pipe is one of the ways to meet this purpose. Conventional ornaments for the exhaust tail pipe usually provide only decorative effect. They mostly cover the tail end of the exhaust pipe and change the exterior form, or add lighting features on the ornaments to provide nightlight effect. Because of technical limitations, their effects are not desirable. Moreover, conventional products generally have complicated structure and higher costs. Besides offering decorative effect, they do not have much practical value. In the highly competitive market these days, a successful product has to offer more practical value and a lower price to benefit consumers.

### SUMMARY OF THE INVENTION

Therefore the primary object of the invention is to resolve the aforesaid disadvantages. The invention aims at coupling an accessory on the tail end of a car exhaust pipe that equips with a luminous element to generate light for alarming thereby to enhance drive safety and provide decorative effect.

The foregoing, as well as additional objects, features and advantage of the invention will be more readily apparent from the following detailed description, which proceeds with reference to the accompanying drawings.

### BRIEF DESCRIPTION OF THE DRAWINGS

FIG. 1 is a perspective view of the present invention;

FIG. 2 is an exploded view of the present invention;

FIG. 3 is a sectional view of the present invention;

FIG. 4 is a schematic view of another embodiment of the present invention;

FIG. 5 is a schematic view of the present invention in use.

### DETAILED DESCRIPTION OF THE PREFERRED EMBODIMENTS

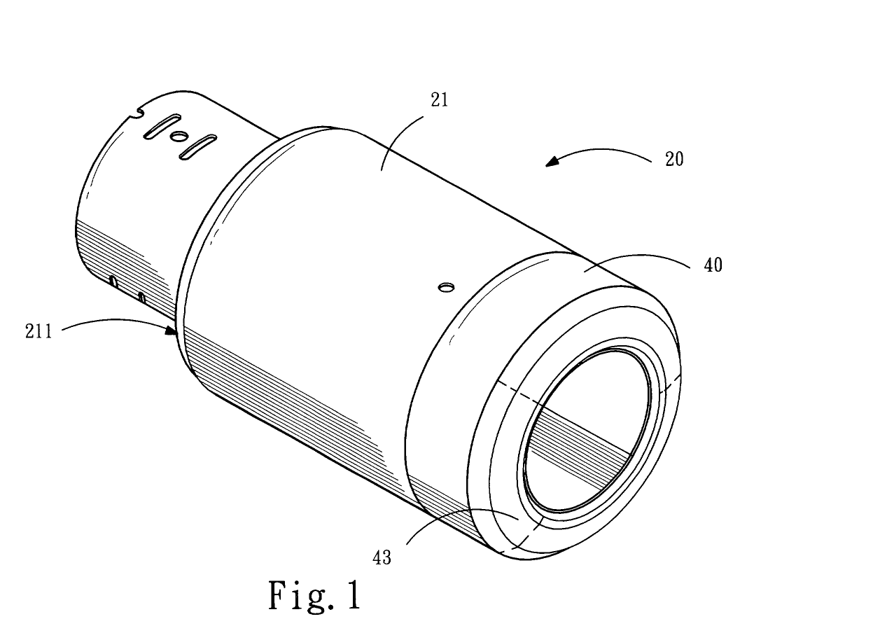

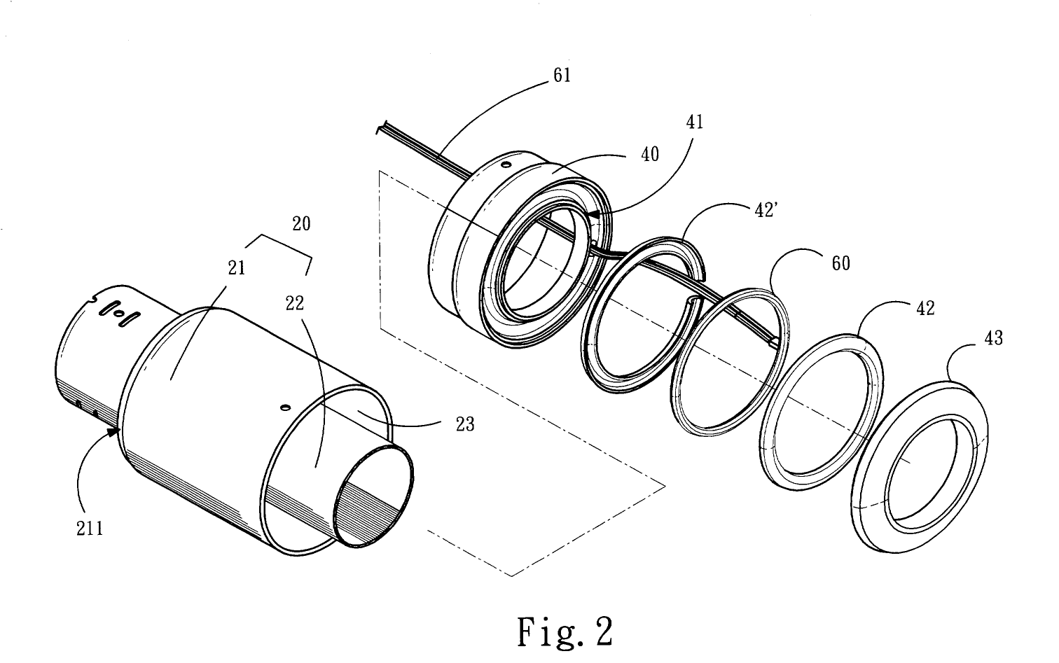

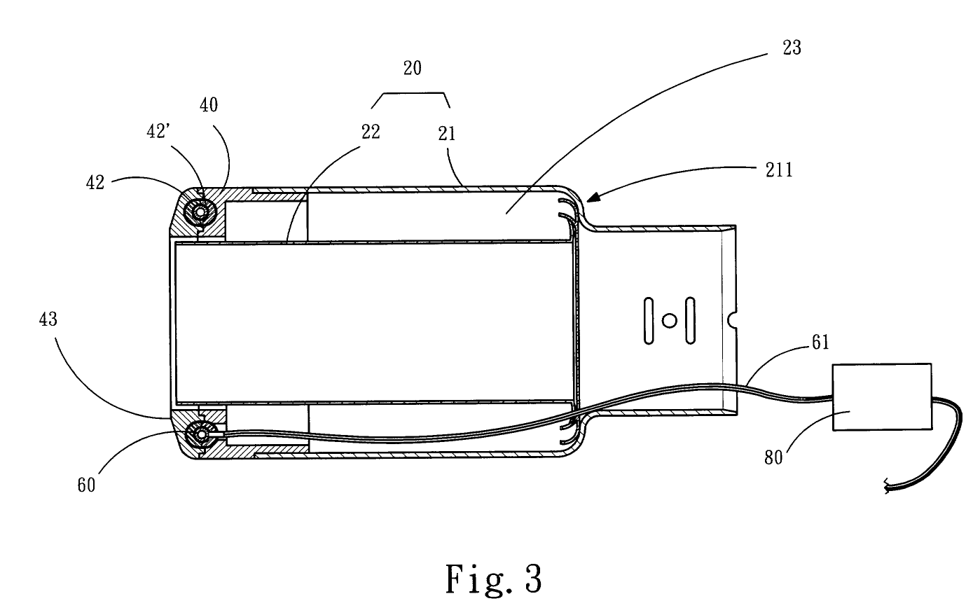

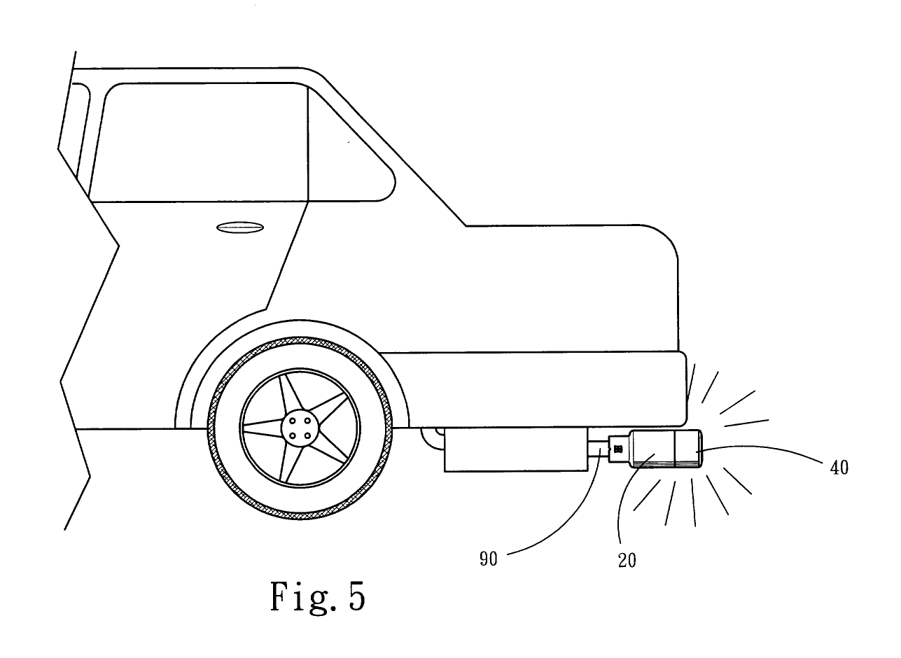

Referring to FIGS. 1, 2, and 3, the accessory of the invention consists of a barrel 20, a coupler 40 and a luminous element 60. The barrel 20 is fastened to a tail end 90 of a car exhaust pipe (also referring to FIG. 5). The barrel 20 includes an external duct 21 and an inner duct 22 connecting to the external duct 21. There is an interval 23 of a desired distance formed between the external duct 21 and the inner duct 22. The external duct 21 has two ends with different diameters. The inner duct 22 is connected to a selected spot 211 located in the external duct 21 by soldering in an embodiment of the invention. Of course other connection methods such as screwing, wedging, screw thread coupling, riveting or the like may also be used. In addition, the connection juncture between the outer duct 21 and the inner duct 22 has one or more aperture (not shown in the drawings) to facilitate air ventilation and heat dissipation.

The coupler 40 is fastened to one end of the barrel 20, and is wedged in the interval 23 between the outer duct 21 and the inner duct 22, and also is spaced from the inner duct 22 with a desired gap. The coupler 40 is fastened to the barrel 20 by riveting in an embodiment of the invention. Of course other fastening methods such as wedging, screw thread coupling, screwing or the like may also be used. The coupler 40 has an annular housing compartment 41 for housing at least one pad ring 42 (two pad rings are used in the embodiment). The barrel 40 has a front end covered by a light radiation element 43. The light radiation element 43 is fastened to the barrel 40 by a suitable method such as supersonic bonding adopted in the embodiment.

Moreover, the coupler 40 may be made from a transparent material that can radiate light, such as transparent plastics, colored plastics, smoked surface plastics or other materials with equivalent effect. The light radiation element 43 is formed to radiate light in a plane fashion, and is made from a transparent and light scattering material. It also may be printed with patterns such as warning signs or company logos. The coupler 40 and the light radiation element 43 may also be formed in various shapes for decorative purpose to increase the added value of the invention.

The luminous element 60 is located in the pad ring 42 held in the housing compartment 41 to get a desired positioning and protection. The luminous element 60 may be a fluorescent lamp, LED lamp, light bulb or other lighting articles of equivalent effect. The luminous element 60 is connected to a conductive wire 61 of high-temperature resistant and fire-proof for linking to the 12V power supply of the car to obtain the required power supply. Another approach is to connect the luminous element 60 to a transformer 80, then connect to the power supply of the car to control the lighting fashion of the luminous element 60 (such as blinking at a selected interval, controlling on and off of lighting, etc).

By means of the aforesaid construction, when the invention is installed on the tail end 90 of the car exhaust pipe, the luminous element 60 emits light through the coupler 40 and the light radiation element 43 to form ornamental light. In addition to decorate the tail end 90 of the exhaust pipe, it also has more practical function such as alarming to improve drive safety of the car.

Through the light radiation element 43, light generated by the luminous element 60 from a point or line source may be refracted to become a plane light source to illuminate the printed patterns on the transparent panel to make the contour and appearance look more appealing. It also can function as an alarm light. When coupled with the transformer 80, it can be synchronized with driving conditions such as turning on concurrently with the brake light to alert the following cars and enhance drive safety.

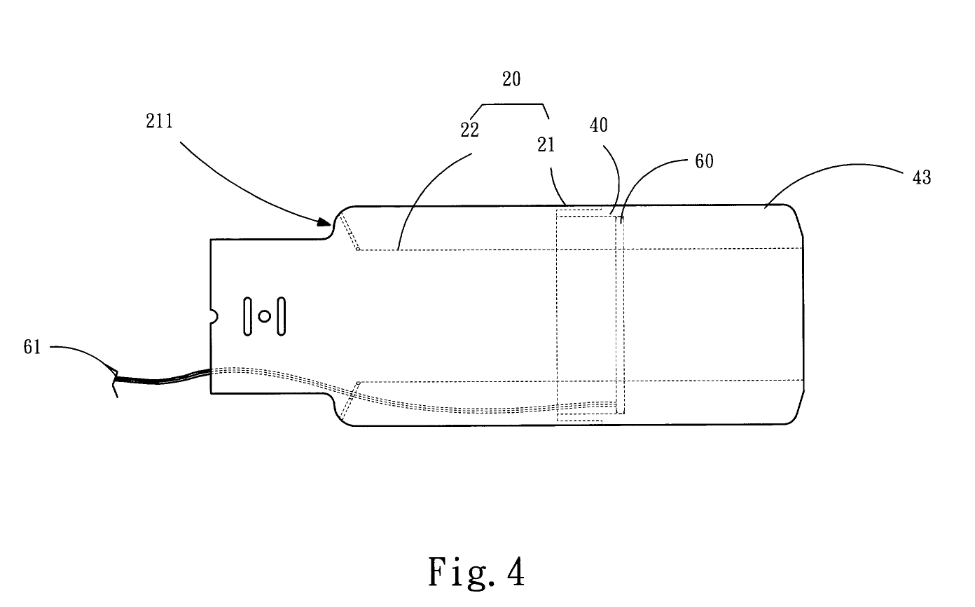

Refer to FIG. 4 for another embodiment of the invention. As shown in the drawing, in order to augment the warning and decorative effects, the coupler 40 has some alterations to match the outer duct 21, such as increasing the length of the light radiation element 43 and reducing the length of the outer duct 21, and the radiation element 43 covering the coupler 40, and the light radiation element 43, coupler 40 and outer duct 21 are fastened together by a desired method (such as riveting). By means of these alterations, a greater luminous area may be obtained to provide even better and more versatile warning effects. Another alternative is to increase the length of the radiation element 43 to provide more space for printing patterns to increase decorative effect.

FIG. 5 illustrates an example of the invention in use. The outer duct 21 has a smaller diameter to couple with the tail end 90 of the car exhaust pipe. A plurality of fasteners (not shown in the drawing) may be used to run through the outer duct 21 to form a secured fastening with the tail end 90 of the exhaust pipe.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments, which do not depart from the spirit and scope of the present invention.

What is claimed is:

1. An external accessory of a car exhaust pipe, comprising at least:
a barrel connecting to a tail end of the car exhaust pipe and having one end;
a coupler fastened to the one end of the barrel; and
at least one luminous element located in the coupler to emit light for warning or decorative use to improve drive safety.

2. The external accessory of a car exhaust pipe of claim 1, wherein the barrel includes an outer duct and an inner duct fastened to the interior of the outer duct, the outer duct being spaced from the inner duct for an interval of a desired distance.

3. The external accessory of a car exhaust pipe of claim 2, wherein the outer duct has two ends of two different diameters, the inner duct being fastened to the interior of the outer duct on a desired location thereof, the fastened location having at least one aperture formed thereon.

4. The external accessory of a car exhaust pipe of claim 2, wherein the coupler is coupled in the interval between the outer duct and the inner duct through a desired means, the coupler being spaced from the inner duct for a desired gap.

5. The external accessory of a car exhaust pipe of claim 4, wherein the desired means for coupling is selected from the methods consisting of screwing, soldering, wedging, coupling by screw threads, or riveting.

6. The external accessory of a car exhaust pipe of claim 1, wherein the coupler has a front rim fastened to a light radiation element and one end formed an indented housing compartment.

7. The external accessory of a car exhaust pipe of claim 6, wherein the housing compartment is annular and contains at least one pad ring.

8. The external accessory of a car exhaust pipe of claim 6, wherein the coupler and the light radiation element are made from a transparent material selected from the group consisting of transparent plastics, colored plastics, or smoke surface plastics.

9. The external accessory of a car exhaust pipe of claim 1, wherein the luminous element is selected from the group consisting of a fluorescent lamp, a LED lamp or a lamp bulb, and is connected to a conductive wire of high-temperature resistant and fire-proof.

10. The external accessory of a car exhaust pipe of claim 9, wherein the conductive wire connects to a transformer.

11. An external accessory of a car exhaust pipe, comprising at least:
a barrel connected to a tail end of the car exhaust pipe having an outer duct and an inner duct fastened to the interior of the outer duct, the outer duct being spaced from the inner duct for an interval of a desired distance;
a coupler fastened to the one end of the barrel having a housing compartment and a front rim covered by a light radiation element; and
a luminous element located in the housing compartment;
wherein the luminous element emits alarming or decorative light for enhancing drive safety or decorative use.

12. The external accessory of a car exhaust pipe of claim 11, wherein the outer duct has two ends of different diameters, the inner duct being fastened to the interior of the outer duct on a desired location, the fastened location having at least one aperture formed thereon.

13. The external accessory of a car exhaust pipe of claim 11, wherein the coupler is fastened in the interval between the outer duct and the inner duct through a desired means, the coupler being spaced from the inner duct for a desired gap.

14. The external accessory of a car exhaust pipe of claim 13, wherein the desired means of fastening is selected from the methods consisting of screwing, soldering, wedging, coupling by screw threads, or riveting.

15. The external accessory of a car exhaust pipe of claim 11, wherein the housing compartment is annular and contains at least one pad ring.

16. The external accessory of a car exhaust pipe of claim 11, wherein the coupler and the light radiation element are made from a transparent material selected from the group consisting of transparent plastics, colored plastics, or smoke surface plastics.

17. The external accessory of a car exhaust pipe of claim 11, wherein the luminous element is selected from the group consisting of a fluorescent lamp, a LED lamp or a lamp bulb, and is connected to a conductive wire of high-temperature resistant and fire-proof.

18. The external accessory of a car exhaust pipe of claim 17, wherein the conductive wire connects to a transformer.
